(19) United States
(12) Patent Application Publication
(10) Pub. No.: US 2006/0174212 A1
(43) Pub. Date: Aug. 3, 2006

(54) Information presentation on wide-screen displays

(75) Inventor: Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/048,095

(22) Filed: Feb. 1, 2005

(51) Int. Cl. G06F 3/00

(52) U.S. Cl. 715/786; 715/792

(57) ABSTRACT

A graphic user interface optimized for the presentation of information from a file on a wide-screen display comprising: a) a windowed display having at least first and second information presentation sections for concurrently displaying portions of sequential information from the file; and b) a common scrolling mechanism for changing the portions of sequential information concurrently displayed in the presentation windows.

### FIELD OF THE INVENTION

The present invention relates to user interfaces for information interaction and, more particularly, to graphic user interfaces for wide-screen displays.

### BACKGROUND OF THE INVENTION

Information display device devices are well known and used for a wide variety of applications for which information, and user interaction with information, are critical. Monitors associated with computers are a typical and widely used example. A typical monitor has a standard aspect ratio of approximately 4:3 and is slightly wider than it is high when viewed by a user seated or standing in front of the monitor. Many modem computers are capable of driving such monitors at a variety of pixel resolutions, for example 800 by 600, 1280 by 1024, 1600 by 1200 and 1920 by 1200.

Graphic user interfaces (GUIs) are the conventional means for interacting with, and controlling, a computer today. The graphic user interface is typically controlled by the computer's operating system and provides means for organizing files, running application software, for example text editors, spreadsheets, and presentation software for presenting information to groups of people. The application software typically employs related graphic elements, for example, windows, panes, buttons, tool bars, menus, scroll bars, and the like, as are commonly found in graphic user interfaces today. The graphic elements are operated through a computer mouse or through special keyboard key combinations, known as keyboard shortcuts. In particular, windows are graphic objects within which application software user interfaces are presented. Such windows may be opened, closed, moved, and resized in a display. Within a window graphic elements may be presented; typically such graphic elements provide interfaces to operations on information manipulated by the application. In a typical prior-art user interface one set of graphic controls are associated with each window.

Within some application windows, panes may be employed to present information. Multiple panes may be used to present multiple views of information from one or more files. Panes may have associated controls whose operations are limited to the information presented in the panes. In particular, scroll bars may be employed to present a portion of the information in a file of sequentially organized information, for example a text file or presentation file.

Given the plethora of information presented to users of computing devices, it is important that the displays be efficiently used so as to present as much useful information as possible while maintaining clarity and ease of use when interacting with the presented information. For example, U.S. Pat. No. 6,724,403 B1 and US 20030020671 A1 both entitled “System and method for simultaneous display of multiple information sources” describe a computerized method of presenting information from a variety of sources on a display device. Specifically the invention describes a graphic user interface for organizing the simultaneous display of information from a multitude of information sources using a tile structure. Likewise, U.S. Pat. No. 6,725,427 B2 entitled “Document stream operating system with document organizing and display facilities” discloses a document stream operating system and method in which: (1) documents are stored in one or more chronologically ordered streams; (2) the location and nature of file storage is transparent to the user; (3) information is organized as needed instead of at the time the document is created; (4) sophisticated logic is provided for summarizing a large group of related documents at the time a user wants a concise overview; and (5) archiving is automatic. The documents can include text, pictures, animations, software programs or any other type of data.

A variety of applications can be considered in presenting useful information to a user in efficient ways. US20030137522 A1 entitled “Innovations for the display of web pages” describes the use of a simultaneous overview and magnified view of a web page. Similarly, EP1215570 A1 entitled “Providing a windows-based user interface” describes a method for providing a windows-based user interface adapted to provide a plurality of windows for executing application programs and for user interaction displayable by an external browser. Tools may also be provided for moving between applications in a multi-threaded computer operating system. For example, US20020149615 A1 entitled “Navigation tool for accessing workspaces and modules in a graphic user interface” describes a method and system for displaying information related to a plurality of resources in a network environment.

In typical prior-art presentation software applications, a single window with scroll bars may be employed for presenting portions of sequential information from a file. In some applications, windows may be horizontally split into two or more separate panes. The information presented within the panes may be the same or related information so that if the information is modified, by editing, for example, the change in information may be shown in both panes. It is also known to provide separate windows that present the same information, or different portions of the same information. It is also possible to provide a separate copy of information in a separate window, and to modify the information in the separate copy. However, in this case, any modifications made on one copy are not present in other copies and not shown in any other windows presenting the information from the other copies.

As shown in the prior-art illustration of FIG. 2, textual information (for example, text document, spreadsheet documents, and presentation documents) is conventionally presented in a pane within a window and multiple views of portions of a single text file of sequential information may be provided. Referring to FIG. 2, a conventional format display 10 has a single windowed interface 12 in an application for editing a text file. Text 15 is shown in a pane 14. Vertical scroll bars 20 with sliders 30 are used to change the portion of the text file presented in the pane; by operating the scroll bar controls the portion of text in the file presented may be moved forward or backward. A horizontal scroll bar 22 is used to change the view of the portion of lines of text from the left to the right. FIG. 3, illustrates multiple views of the text in separate panes 14a and 14b of a single window 12. Information may also be presented in the form of multiple columns 16 within a single pane 14 of a window 12 as illustrated in FIG. 4.

While these innovations are useful in optimizing the utility of a windowed user interface for information presentation and application control, they are still limited by the resolution of the display on which the information and applications are presented. By expanding the resolution and size of an interactive display, increased screen space may be provided. For example, US20040239890 A1 entitled “Curved-screen immersive rear projection display” describes an immersive rear projection display capable of providing aspect ratios of 2.66:1 or 4:1, or even greater. This allows viewers to be “immersed” in the images being displayed because the images can encompass both the direct and the peripheral views of a viewer. In one implementation, the immersive rear-projection display includes two or more electronic projectors (e.g., three) that are positioned behind a curved translucent display screen. The electronic projectors project respective display images adjacent each other onto the display screen. Regardless of the technology employed to present information in a wide-screen format (i.e., formats having an aspect ratio of greater than 4:3), this approach can provide additional horizontal resolution in a monitor that can be employed to display additional information.

However, prior-art windowed graphic user interfaces are not optimized for efficient use and navigation within a wide-screen display. In particular, moving a pointing device, such as a cursor controlled by a mouse or trackball, is tedious because of the extent of the screen, and appreciating the structure of the sequential information may be difficult. In particular, multiple panes of sequential information are not easily shown and manipulated, for example a sequence of pages.

There is a need therefore for an improved user interface design for information presentation and interaction on a wide-screen display.

### SUMMARY OF THE INVENTION

In accordance with one embodiment, the present invention is directed towards a graphic user interface optimized for the presentation of information from a file on a wide-screen display comprising: a) a windowed display having at least first and second information presentation sections for concurrently displaying portions of sequential information from the file; and b) a common scrolling mechanism for changing the portions of sequential information concurrently displayed in the presentation windows.

### ADVANTAGES

The present invention has the advantage that it provides improved efficiency for user interaction with data in a wide-screen format.

### BRIEF DESCRIPTION OF THE DRAWINGS

FIG. 1 is a depiction of a graphic user interface having three presentation sections and a wide-screen display according to one embodiment of the present invention;

FIG. 2 is a depiction of a prior-art graphic user interface window on a conventional monitor with a 4:3 aspect ratio;

FIG. 3 is a depiction of a prior-art graphic user interface window with multiple panes;

FIG. 4 is a depiction of a prior-art graphic user interface window with multiple columns;

FIG. 5 is a depiction of a graphic user interface having three docked presentation sections according to another embodiment of the present invention; and

FIG. 6 is a depiction of a graphic user interface having three presentation sections according to an alternative embodiment of the present invention.

### DETAILED DESCRIPTION OF THE INVENTION

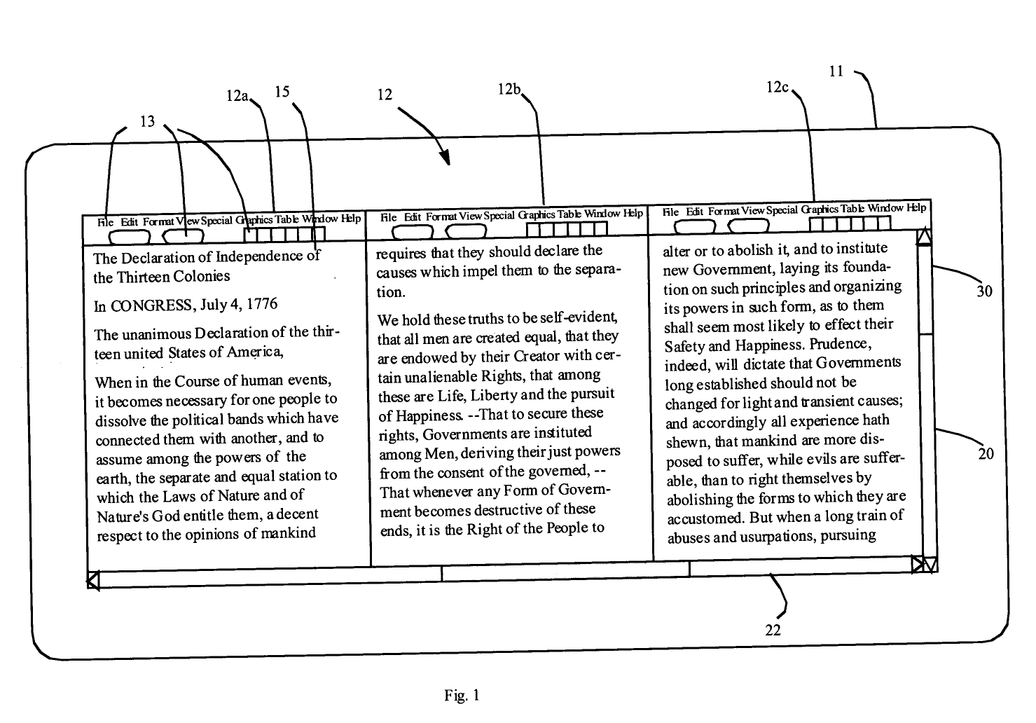

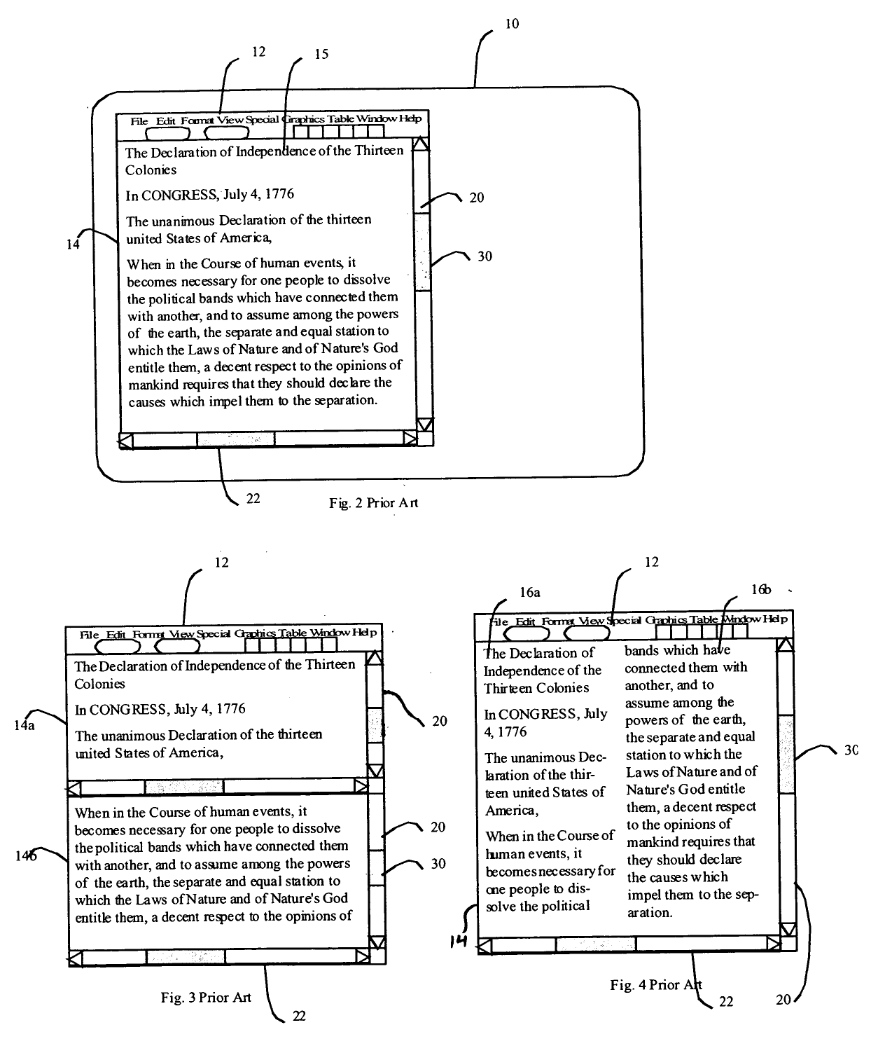

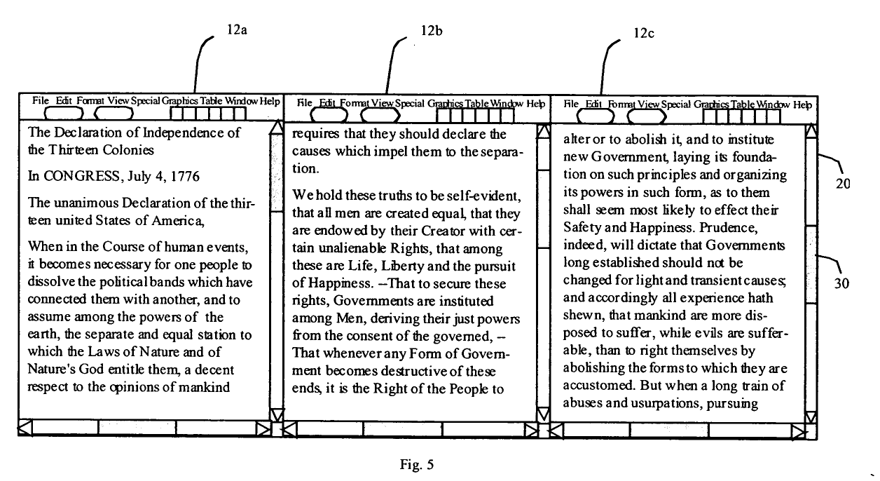

Referring to FIG. 1, a graphic user interface in accordance with one embodiment of the invention optimized for the presentation of information from a file on a wide-screen display 11 comprises: a windowed display 12 having first, second and third information presentation sections 12a, 12b and 12c for concurrently displaying portions of sequential information 15 from the file; and a common scrolling mechanism, for example a horizontal scrolling icon 22 or a common vertical scrolling icon 20 for changing the portions of sequential information concurrently displayed in the presentation sections. As illustrated in FIG. 1, each presentation section 12a-c has a separate set of tool bar and menu controls 13 but only one horizontal and vertical scroll icon 20 and 22 for activating the common scrolling mechanism.

According to the present invention, a common scrolling mechanism is employed for changing the portions of sequential information displayed in the presentation sections. Hence, if a vertical scrolling icon 20 using a conventional set of scroll bar icons is employed to change the portion of sequential information displayed, as the scroll icon is manipulated, the portions of information concurrently presented in each of the presentation sections is changed. Alternatively, a horizontal scroll bar 22 could be used. The scroll bars may be located at the top, bottom, or either side of a presentation section or of a group of presentation sections. In accordance with the invention, the use of a common scrolling mechanism enables the changes in information presented in multiple sections to be performed in response to a single action by a user and, given a sufficiently powerful computer, may appear to a user to happen at the same time. In fact, a conventional single CPU computer will perform the changes sequentially.

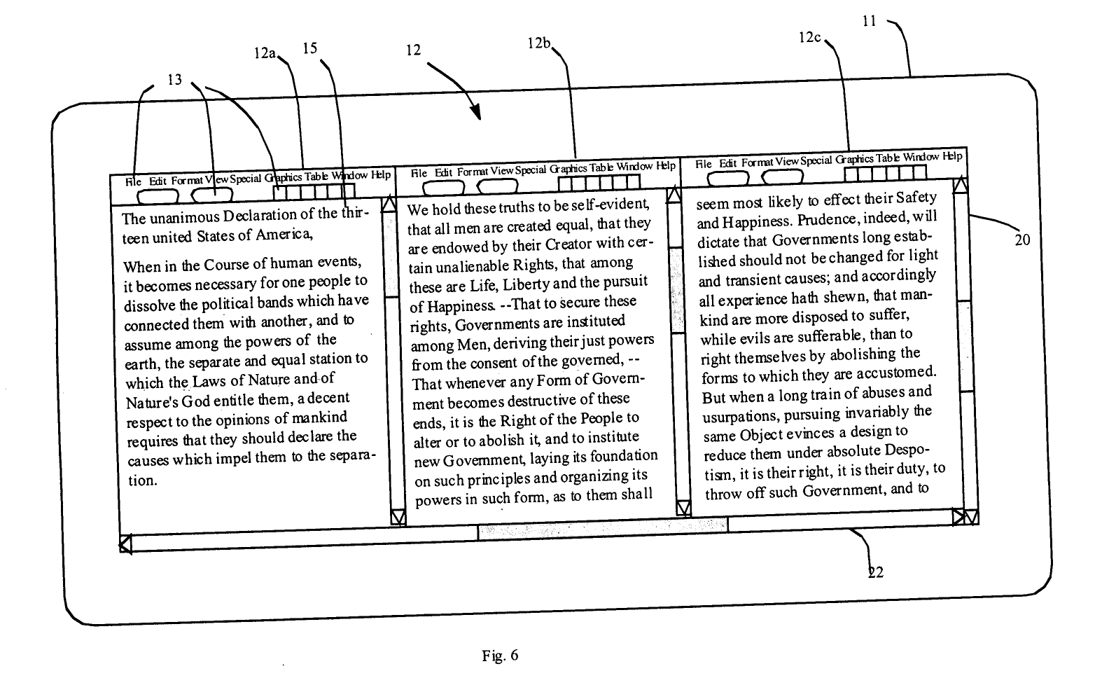

The presentation sections may be individually positioned within a separate window with a separate set of controls but a common scrolling mechanism. Alternatively, the presentation sections may be located within separate panes of a single, common window. In either case, a single scroll icon implementing the scrolling mechanism may be employed (e.g., vertical scroll bar 20 as shown in FIG. 1) or a plurality, for example one per presentation section (as shown for the vertical scroll bars in FIG. 5 and FIG. 6), of scroll icons implementing the common scrolling mechanism.

The information presented by the separate presentation sections may be continuous, may overlap, or may be discontinuous. For example, as illustrated in FIG. 1, each presentation section shows text that flows from one section to the other without omitting any of the sequential information. Thus, the presentation sections show a continuous flow of sequential information. If the sections showed portions of the same text, the presentation sections would overlap. If portions of the text between the portions presented in two of the presentation sections are not displayed, the presentation sections are discontinuous.

A user may interact with the information shown in any of the presentation sections as is done in conventional graphic windowed interfaces for sequential organized information such as text. As with most desktop publishing software applications, if any change is made to the text, it can be modified in the display to illustrate the change in the text so that what the user sees, the user will get when the information is printed (WYSIWYG). However, the present invention is not limited to desktop publishing applications such as are illustrated in FIG. 1. The present invention may by employed in editing any files of sequentially organized information, including those found in spreadsheets and in presentation files used for projection to an audience. Changes made to the content or layout of any of the information will be reflected in any presentation section presenting a portion of the information whose content or layout has been modified as a consequence of the change. For example, such changes may include character substitution, addition, or deletion, or changes in margins and pagination.

The separate presentation sections may be contiguously docked together and manipulated as a group. The sections may be of different sizes, or may be of a single uniform size. Groups of docked presentation sections may be aligned and positioned so that they are touching on whatever side the presentation sections are docked, either horizontally or vertically. Alternatively, the presentation windows may be manipulated separately. As shown in FIGS. 1, 5, and 6, the three presentation sections 12a-c are docked horizontally. Docking provides a useful way of efficiently handling a plurality of presentation sections as a group.

The controls 13 employed by an application are conventionally arranged around the periphery, primarily but not exclusively, at the top of the presentation window. These controls 13 may include, for example, buttons, tool bars, menus, graphic elements, and text elements that, when operated, perform operations on the information or the presentation of the information. Other controls such as scroll bars, affect the portion of information viewed, rather than the information content or layout. These controls may be replicated in each presentation section or a single set of controls may be provided.

As a simple example, consider a sequential text file with conventional words arranged in sentences and paragraphs to form a multi-page document, as shown in FIG. 1. For the purposes of this example, presume that the sequential information displayed in each presentation sections is continuous and shows a different, non-overlapping portion of the sequential information. If one paragraph is removed from the text displayed in one presentation window, the presentation window that displays that paragraph will remove the paragraph from the display and move the text following the excised paragraph up to follow the text just before the excised paragraph. Any other presentation window displaying text that follows the excised paragraph will also have its text moved up in the display. Referring back to FIG. 1, the text in the three presentation windows 12a, 12b, and 12c display a continuous and non-overlapping portion of the information without omissions. If one paragraph in presentation section 12a were deleted, the view of the sequential information displayed in presentation sections 12b and 12c would likewise change. Referring to FIG. 6, the first paragraph has been deleted and the text is correspondingly moved up in each of the three presentation sections 12a, 12b, and 12c. If the sections are not continuous, such that portions of the text between the portions presented in two of the presentation sections are not displayed, changes to information displayed in one section may still result in changes to the portion of information displayed in another section, as format and relative position of the portions of displayed information will be maintained due to use of a common scrolling mechanism. FIG. 6 also illustrates a separate scroll icon associated with each presentation section.

Although, according to various embodiments of the present invention, the presentation sections may be independently located on a display screen, it may be useful to dock the sections together in a physically ordered arrangement that corresponds to the sequential order of the sequential information portions displayed in the presentation sections. For example, as shown in FIG. 1, the presentation sections are docked horizontally and linked so that the presentation sections show a continuous flow of information from one presentation section to the next in the order shown from left to right. If each presentation section were to show a page of the information, the sequential pages would be displayed from left to right.

According to the present invention, a common scroll mechanism is provided. If a single, common scroll icon is employed to provide the scrolling mechanism, the activation of the scroll bar will affect the portions of information shown in every presentation section. That is, all of the sections are scrolled together. If a plurality of scroll bar icons are employed, for example one scroll bar icon for each presentation section (as shown in FIGS. 5 and 6), manipulating any one of the scroll bar icons will affect all of the portions of information displayed in the presentation sections, as well as the other scroll bar icons. As is conventional, the size and position of a slider 30 in a scroll bar may indicate the position and relative quantity of the information displayed in the section. Hence, in the embodiments of FIGS. 5 and 6, where a separate vertical scroll bar is used for each presentation section, moving any one vertical slider 30 will result in all of the vertical sliders 30 moving in concert and all of the portions of information displayed in each presentation section likewise changing in concert. Likewise, if additional presentation portions are provided, the relative size of each slider 30 in the scroll bar may diminish.

Both vertical and horizontal scroll bars may be employed, as shown in FIGS. 5 and 6. In one embodiment, a horizontal scroll bar may be associated with each presentation section and used to locate text on a page, as is done conventionally. In such embodiment, the horizontal scroll bars may or may not be controlled by a common scrolling mechanism. Alternatively, a single horizontal scroll bar may be employed to commonly locate text on a page for all presentation sections. In an alternative embodiment, a single or multiple horizontal scroll bars may be used to locate the portion views of the presentation sections using a common scrolling mechanism. In this latter case, it may be preferred not to employ vertical scroll bars.

The presentation sections of the present invention may be resized as is done with conventional window displays. Software for the graphic user interface of the invention may be programmed to account for user preferences when performing resizing operations. Since the presentation sections have a common scrolling mechanism, if a set of presentation sections displaying continuous portions of information are sized larger, the displayed portions of information in the presentation sections may be made to overlap or they may maintain their continuity, in accordance with user preferences. Similarly, if a set of presentation sections displaying continuous portions of information are sized smaller, the displayed portions of information in the presentation sections may become discontinuous or may maintain their continuity, again in accordance with user preferences. If a set of presentation sections displaying overlapping portions of information are decreased in size, the portions of displayed information may become continuous, or if the portions of displayed information are discontinuous and the presentation sections are increased in size, the portions of displayed information may become continuous. A group of presentation sections may be resized as a group or alternatively may be individually resized.

The present invention is usefully employed with wide-screen displays on which a user interface is presented. As used herein, any display with an aspect ratio greater than 4:3 is considered a wide-screen display. The present invention is improved over the prior art in taking advantage of a wide-screen display while overcoming difficulties inherent in using such a wide-screen display. For example, a large screen enables a greater amount of information to be displayed. If a multiplicity of windows are employed for a corresponding multiplicity of applications, then prior-art windowing designs may suffice. If, however, it is desired to employ the wide screen for editing or otherwise interacting with a greater quantity of sequential information within a single application, providing two or more presentation sections with a common scrolling mechanism enables a user to efficiently view and manipulate larger quantities of information in a familiar way. Since many applications are designed to organize information in pages similar to those that can be printed on standard sheets of paper, it is often easiest for a user to interact with the information in page-sized quantities. Hence, enabling displays of multiple pages in an organized and connected way is useful.

Moreover, in a large wide-screen display, cursor movements over large areas become tedious. For example if a mouse or track-ball is employed to move a cursor across a wide screen, it must be moved a relatively large distance or the control of the cursor must be made very coarse. Neither approach provides a useful solution. By providing multiple presentation sections as described in the present invention, multiple pages may be viewed and manipulated as a group and the distance required to move the cursor to application control icons may be greatly reduced.

The present invention may also be applied to panoramic information display devices. In particular, the use of the present invention is well adapted to applications requiring a relatively large display for a single user. Displays having a wide aspect ratio or a curved display surface are usefully employed, for example a panoramic computer monitor for desktop use. Panoramic computer monitors may include a display device with a curved rigid screen that is employed together with the present invention as a component within an otherwise conventional desktop computer. In a further embodiment of the present invention, the curved monitor may comprise a panoramic display, that is one that has at least a 16:9 ratio between height and width and subtends at least 45 degrees when viewed at a normal viewing distance.

A variety of technologies may be employed to implement a widescreen display, with or without a curved screen. In a preferred embodiment, the invention may be employed in a device that includes Organic Light Emitting Diodes.(OLEDs) which are composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light emitting displays can be used to fabricate such a device.

The invention has been described in detail with particular reference to certain preferred embodiments thereof, but it will be understood that variations and modifications can be effected within the spirit and scope of the invention.

### PARTS LIST

10 display
11 wide-screen display
12, 12a, 12b, 12c presentation sections
13 controls
14a, 14b panes
15 sequential information
16a, 16b columns
20 vertical scroll bar
22 horizontal scroll bar
30 slider

1. A graphic user interface optimized for the presentation of information from a file on a wide-screen display comprising:
a) a windowed display having at least first and second information presentation sections for concurrently displaying portions of sequential information from the file; and
b) a common scrolling mechanism for changing the portions of sequential information displayed in the presentation windows.

2. The graphic user interface of claim 1, wherein the presentation sections are horizontally adjacent.

3. The graphic user interface of claim 1, wherein the common scrolling mechanism comprises a single scroll icon.

4. The graphic user interface of claim 1, wherein the common scrolling mechanism includes a separate scroll icon associated with each presentation section.

5. The graphic user interface of claim 1, wherein the common scroll mechanism comprises a horizontal scroll bar, a vertical scroll bar, or both, located at the top, the bottom or either side of a presentation section.

6. The graphic user interface of claim 5, wherein the vertical or horizontal scroll bar indicates the relative position of the information displayed in an associated presentation section in the sequence of file information.

7. The graphic user interface of claim 1, wherein the first and second presentation sections are within separate windows.

8. The graphic user interface of claim 1, wherein the first and second presentation sections are within separate panes in a common window.

9. The graphic user interface of claim 1, wherein the first presentation section and the second presentation section are linked so that the information displayed in the second presentation section is changed in accordance with changes made to the information displayed in the first presentation section.

10. The graphic user interface of claim 1, wherein the portions of sequential information displayed in the first and second presentation sections are continuous, overlap, or are discontinuous.

11. The graphic user interface of claim 1, further comprising tool bar and menu controls and wherein the first and second presentation sections share the same controls.

12. The graphic user interface of claim 1, further comprising separate tool bar and menu controls associated with each of the first and second presentation sections.

13. The graphic user interface of claim 1, wherein the first and the second presentation sections can be contiguously docked together in either the horizontal and/or vertical directions.

14. The graphic user interface of claim 1, wherein the sequential information comprises text information, spreadsheet information, or presentation information, with or without graphic elements.

15. The graphic user interface of claim 1, further comprising a third information presentation section for concurrently displaying portions of sequential information from the file.

16. A display system comprising the graphic user interface of claim 1 and a wide-screen display on which the user interface is presented.
